(19) United States
(12) Patent Application Publication
(10) Pub. No.: US 2007/0097547 A1
(43) Pub. Date: May 3, 2007

(54) SOFT MAGNETIC FILM, METHOD OF MANUFACTURING SOFT MAGNETIC FILM, THIN FILM MAGNETIC HEAD THAT USES SOFT MAGNETIC FILM, AND METHOD OF MANUFACTURING THIN FILM MAGNETIC HEAD

(75) Inventors: Hisayuki Yazawa, Niigata-ken (JP); Shio Takahashi, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/552,842

(22) Filed: Oct. 25, 2006

(30) Foreign Application Priority Data
Oct. 27, 2005 (JP) 2005-312433

(51) Int. Cl. G11B 5/147; G11B 5/127

(52) U.S. Cl. 360/126; 29/603.01

(57) ABSTRACT

A soft magnetic film and a method of manufacturing the soft magnetic film are provided. The soft magnetic film is plated with Fe and Ni, Fe and Co, or Fe, Ni and Co. A ratio Cl/Fe of ion strengths between negative-charged Fe and Cl and a ratio S/Fe of ion strengths between negative-charged Fe and S are less than about 10 in measurement by a time-of-flight secondary ion mass spectrometry.

This patent document claims the benefit of Japanese Patent Application 2005-312433 filed on Oct. 27, 2005 which is hereby incorporated by reference.

### BACKGROUND

1. Field

The present embodiments relate to a soft magnetic film, a method of manufacturing the soft magnetic film, a thin film magnetic head that uses the soft magnetic film, and a method of manufacturing the thin film magnetic head.

2. Related Art

A perpendicular magnetic recording method is used in an apparatus for recoding magnetic data with high density on a recording medium such as a hard disk. The perpendicular magnetic recording method is advantageous in terms of high recording density more than a longitudinal magnetic recording method.

A magnetic head used in the perpendicular magnetic recording method generally includes a main magnetic pole layer and a sub magnetic pole layer (return yoke) that face each other in a film thickness direction on a surface that faces a recording medium, and a coil layer for applying a recording magnetic field on the main and sub magnetic pole layers.

The surface that faces the recording medium of the main magnetic pole layer has a track width Tw, and the area of main magnetic pole layer on the surface that faces the recording medium is sufficiently small relative to the area of sub magnetic pole layer on the surface that faces the recording medium.

In the perpendicular magnetic recording method, when electric current flows through the coil layer, the recording magnetic field is induced on the main and sub magnetic pole layers, such that the recording magnetic field is generated in a perpendicular direction from the main magnetic pole layer toward the recording medium.

The recording medium includes a hard film with a high coercive force on its surface and a soft film with a high magnetic permeability on its inner side. The recording magnetic field generated in a perpendicular direction from the main magnetic pole layer of the perpendicular magnetic recording head toward the recording medium forms a magnetic circuit by passing through the hard and soft films of the recording medium and returning to the sub magnetic pole layer.

Generally, the main magnetic pole layer needs to have high saturation magnetic flux density Bs and low coercive force for high recording density purpose. At a low saturation magnetic flux density Bs, an end of main magnetic pole layer is apt to reach magnetic saturation, such that it is not possible to properly concentrate the magnetic flux on the end of main magnetic pole layer. Thus, it is not possible to improve the recording density. Accordingly, the saturation magnetic flux density Bs should be high. In addition, when the coercive force Hc is high, residual magnetism leaks from the main magnetic pole layer with a very narrow track width Tw at moments other than the time of recording, thereby eliminating signals recorded beforehand. Accordingly, the coercive force should be low.

The soft magnetic film that constitutes the main magnetic pole layer contains impurities other than magnetic elements, for example, Fe, Co and Ni. A time-of-flight secondary ion mass spectrometry (hereinafter, referred to as a TOF-SIMS) can make a quantitative analysis of the impurities.

However, a very small amount (i.e. in ppm units) of impurities is injected into the soft magnetic film, which is not regarded to have a serious effect on soft magnetic characteristics. Accordingly, the concentration of impurities has not been controlled in the related art.

For example, JP-A-2004-158818 (US Pub. No. 2004053077A1) discloses a CoFe alloy that contains no saccharine sodium that has been contained in a plating bath, thereby increasing the saturation magnetic flux density Bs. However, JP-A-2004-158818 (US Pub. No. 2004053077A1) does not disclose additives conventionally contained in the plating bath other than the saccharine sodium, and a relationship between the amount of additives and the saturation magnetic flux density Bs.

For example, as described in paragraphs [0092] to [0096] of JP-A-2004-158818 (US Pub. No. 2004053077A1), the plating bath contains NaCl to increase the conductivity of plating bath. The plating bath may contain ammonium chloride instead of NaCl. Since a uniform electrodeposition performance is deteriorated in a plating bath with a low conductivity in any case, it has been considered to be natural that the chloride is contained in the plating bath. Cl is not detected even though the composition of soft magnetic film is analyzed with X-ray fluorescence (XRF). However, Cl is detected as a negative-charged secondary ion by the TOF-SIMS. For example, Cl is contained in the soft magnetic film even though its amount is very small. Further, impurities such as Cl have not been particularly controlled until now.

Accordingly, a soft magnetic film that has a high saturation magnetic flux density with coercive force maintained to be low is desired. A method of manufacturing the soft magnetic film by appropriately controlling the ratio Cl/Fe between ion strengths of negative-charged Fe and Cl that are measured by a time-of-flight secondary ion mass spectrometry is also desired.

### SUMMARY

In one embodiment, a soft magnetic film is plated with Fe and Ni, Fe and Co, or Fe, Ni and Co. In this embodiment, a ratio Cl/Fe of ion strengths between negative-charged Fe and Cl and a ratio S/Fe of ion strengths between negative-charged Fe and S are less than 10 in measurement by a time-of-flight secondary ion mass spectrometry (hereinafter, referred to as a TOF-SIMS). It is possible to obtain a higher saturation magnetic flux density with the coercive force being maintained to be low.

In the above-mentioned embodiment, it is preferable that the ratio Cl/Fe is 2 or less. Accordingly, it is possible to obtain a higher saturation magnetic flux density.

In another embodiment, a thin film magnetic head includes a main magnetic pole layer that has a track width on a surface that faces a recording medium. A sub magnetic pole layer has a width wider than the main magnetic pole layer so as to face the main magnetic pole layer in a film thickness direction. A coil layer applies a recording magnetic field to the main and sub magnetic pole layers. In this embodiment, magnetic data is recorded on the recording medium by a perpendicular magnetic field concentrated on the main magnetic pole layer. At least the main magnetic pole layer is plated with the above-mentioned soft magnetic film. Accordingly, since the main magnetic pole layer has high saturation magnetic flux density and low coercive force, it has high recording density and residual magnetization is suppressed. It is possible to efficiently prevent recording signals from being eliminated due to the residual magnetization.

According to another embodiment, there is provided a method of manufacturing a soft magnetic film in a plating bath that contains no chloride and no saccharine sodium, and contains Fe and Ni ions, Fe and Co ions, or Fe, Ni and Co ions.

The plating bath does not contain chloride such as NaCl that is contained to enhance the conductivity of a conventional plating bath. In addition, saccharine sodium is not added. Accordingly, it is possible to simply and appropriately form the soft magnetic film in which the ratio Cl/Fe of ion strengths of negative-charged Fe and Cl and the ratio S/Fe of ion strengths of negative charged Fe and S are less than 10 in measurement by the time-of-flight secondary ion mass spectrometry.

In the above-mentioned method, it is preferable that boric acid be contained in the plating bath until the boric acid is saturated in the plating bath. Chloride such as NaCl is used to enhance the conductivity of the plating bath is not contained in the bath. The resistance of plating bath increases, causing uniform electrodeposition performance to be deteriorated. Accordingly, it is possible to enhance the uniform electrodeposition performance by adding boric acid close to its saturation concentration in the plating bath in order to suppress variation in pH of the plating bath.

According to another embodiment, a method of manufacturing a thin film magnetic head includes a main magnetic pole layer that has a track width on a surface that faces a recording medium, a sub magnetic pole layer that has a width wider than the main magnetic pole layer so as to face the main magnetic pole layer in a film thickness direction, and a coil layer that applies a recording magnetic field to the main and sub magnetic pole layers, so that magnetic data is recorded on the recording medium by a perpendicular magnetic field concentrated on the main magnetic pole layer. At least the main magnetic pole layer is plated by the above-mentioned method of manufacturing the soft magnetic film.

It is possible to easily and appropriately plate the main magnetic pole layer with a magnetic layer that has a higher saturation magnetic flux density with the coercive force maintained to be low.

In one embodiment, soft magnetic film has a higher saturation magnetic flux density Bs with coercive force maintained to be low.

In one embodiment, the plating bath does not contain chloride, such as NaCl, and saccharine sodium that are contained to enhance the conductivity of a conventional plating bath. It is possible to simply and appropriately form the soft magnetic film in which the ratio Cl/Fe of ion strengths of negative-charged Fe and Cl and the ratio S/Fe of ion strengths of negative charged Fe and S are less than about 10 in measurement by the time-of-flight secondary ion mass spectrometry.

### BRIEF DESCRIPTION OF THE DRAWINGS

FIG. 1 is a cross-sectional view of a perpendicular magnetic recording head according to one embodiment;

FIG. 2 is a cross-sectional view of a perpendicular magnetic recording head according to one embodiment;

FIG. 3 is a partial plan view of the perpendicular magnetic recording head as shown in FIG. 1 with a protection layer removed;

FIG. 4 is a front view of a thin film magnetic head according to one embodiment;

FIG. 5 is a cross-sectional view of the longitudinal magnetic recording head as seen from the line 5-5 shown in an arrow direction of FIG. 4;

FIG. 6 is a timing diagram of modulation pulses according to one embodiment;

FIG. 7 is a graph that shows saturation magnetic flux densities Bs of samples that are plated in a plating bath without NaCl in first and second embodiments and samples that are plated in a plating bath with NaCl in first and second comparative examples;

FIG. 8 is a graph that shows a ratio Cl/Fe between ion strengths of negative-charged Fe and Cl when individual samples are measured by a TOF-SIMS in the embodiments and first, second, third, and fourth comparative examples;

FIG. 9 is a graph that shows a ratio S/Fe between ion strengths of negative-charged Fe and S when individual samples are measured by a TOF-SIMS in the embodiments and first, second, third, and fourth comparative examples; and

FIG. 10 is a graph that shows an ion strength ratio (%) of positive-charge Na when individual samples are measured by a TOF-SIMS in the embodiments and the first and the second comparative examples.

### DETAILED DESCRIPTION

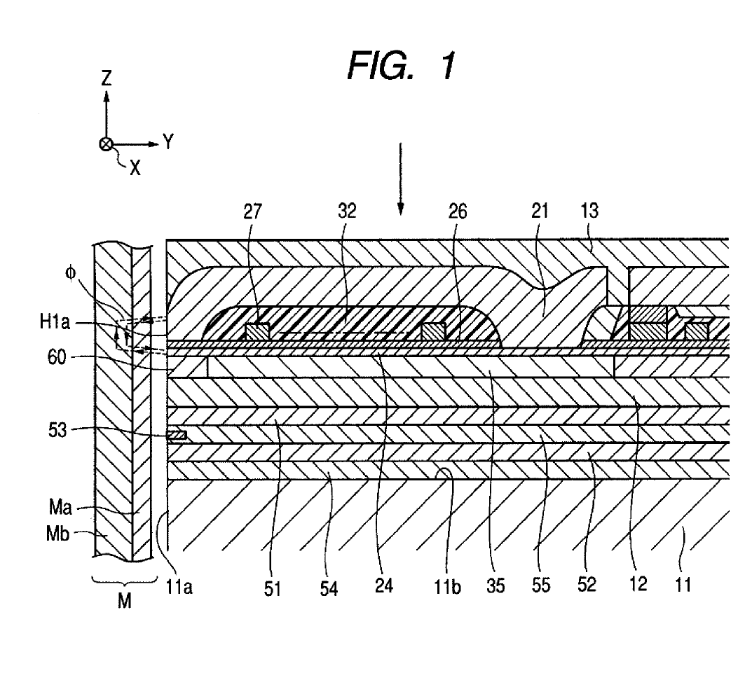

FIG. 1 is a cross-sectional view of a perpendicular magnetic recording head according to one embodiment.

In FIG. 1, the X-direction denotes a track-width direction, Y-direction denotes a height direction, and Z-direction denotes an altitude direction. One direction is orthogonal to the other directions. The term “surface that faces a recording medium” implies a surface parallel to the X-Z plane. FIG. 1 is a cross-sectional view of a perpendicular magnetic recording head that is cut in a direction parallel with the Y-Z plane.

A perpendicular magnetic recording head (thin film magnetic head) shown in FIG. 1 applies a perpendicular magnetic field to a recording medium M so as to magnetize a hard film Ma of the recording medium M in a perpendicular direction.

The recording medium M is, for example, a disk shape. The recording medium M includes a hard film Ma with a high coercive force on its surface and a soft film Mb with a high magnetic permeability on its inner side, and rotates about the center of disk.

A slider 11 of the perpendicular magnetic recording head is formed of non-magnetic materials, for example, Al₂O₃.TiC. A surface 11a of the slider 11 faces the recording medium M. When the recording medium M rotates, the slider 11 floats above a surface of the recording medium M, or slides on the recording medium M. In FIG. 1, the recording medium M moves in the Z-direction with respect to the slider 11.

In one embodiment, a non-magnetic insulating layer 54 is made of inorganic materials such as Al₂O₃ or SiO₂ and is formed on a trailing end surface 11b of the slider 11. A lower shield layer 52 is formed on the non-magnetic insulating layer. A magnetoresistive effect element 53 is formed on the lower shield layer 52 with a lower gap layer interposed therebetween. An upper shield layer 51 is formed on the magnetoresistive effect element 53 with an upper gap layer interposed therebetween.

In one embodiment, as shown in FIG. 1, the lower and upper gap layers form an insulating layer 55. An insulating layer 12 made of inorganic materials such as Al₂O₃ or SiO₂ is formed on the upper shield layer 51. A perpendicular magnetic recording head is formed on the insulating layer 12. The perpendicular magnetic recording head is coated with a protection layer 13 made of inorganic non-magnetic insulation materials. A surface H1a of the perpendicular magnetic recording head faces the recording medium and is almost flush with the surface 11a of the slider 11.

A yoke layer 35 made of magnetic materials is formed on the insulating layer 12. The yoke layer 35 is formed to be apart from the surface H1a in the height direction (Y-direction). An insulating layer 60 is formed at the front of the yoke layer 35.

In one embodiment, as shown in FIG. 1, a main magnetic pole layer 24 is formed on the insulating layer 60 and the yoke layer 35. A gap layer 26 made of insulation materials is formed on the main magnetic pole layer 24. A coil layer 27 is formed on the gap layer 26. The coil layer 27 is covered with an organic insulating layer 32.

In one embodiment, as shown in FIG. 1, ferromagnetic materials such as permalloy (Ni—Fe) are applied on the organic insulating layer 32 to form a sub magnetic pole layer 21. The sub magnetic pole layer 21 faces the main magnetic pole layer 24 on the surface H1a with the gap layer 26 interposed therebetween. In addition, the sub magnetic pole layer 21 is magnetically connected on the main magnetic pole layer 24 around a base portion in the height direction.

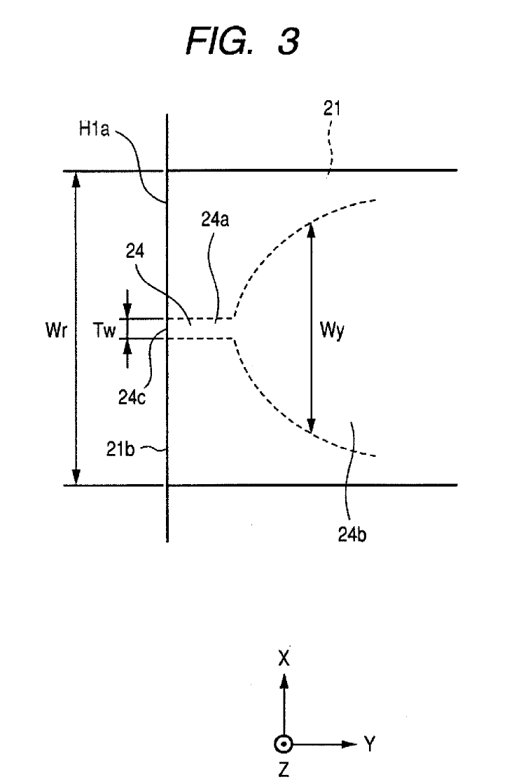

In one embodiment, as shown in FIG. 3, the main magnetic pole layer 24 includes a front end portion 24a, which has a thin and long shape with a track width Tw in a track width direction (X-direction) of its front end surface 24c with a track width Tw, and a rear end portion 24b, which is formed in the height direction (Y-direction) of the front end portion 24a and has width Wy gradually increasing as it becomes distant from the surface H1a.

As shown in FIG. 3, on the surface H1a, the width Wr of the front end surface 21b of the sub magnetic pole layer 21 is sufficiently smaller than the track width Tw of the front end surface 24c of the main magnetic pole layer 24. The sub magnetic pole layer 21 has a thickness smaller than the main magnetic pole layer 24, as shown in FIG. 1. The front end surface 24c of the main magnetic pole layer 24 has an area much smaller than the front end surface 21b of the sub magnetic pole layer 21. The main magnetic pole layer 24 has a thickness that is smaller than the yoke layer 35. For example, the main magnetic pole layer 24 has a track width Tw as small as about 0.1 to 0.2 μm and a height as small as about 0.2 to 0.3 μm.

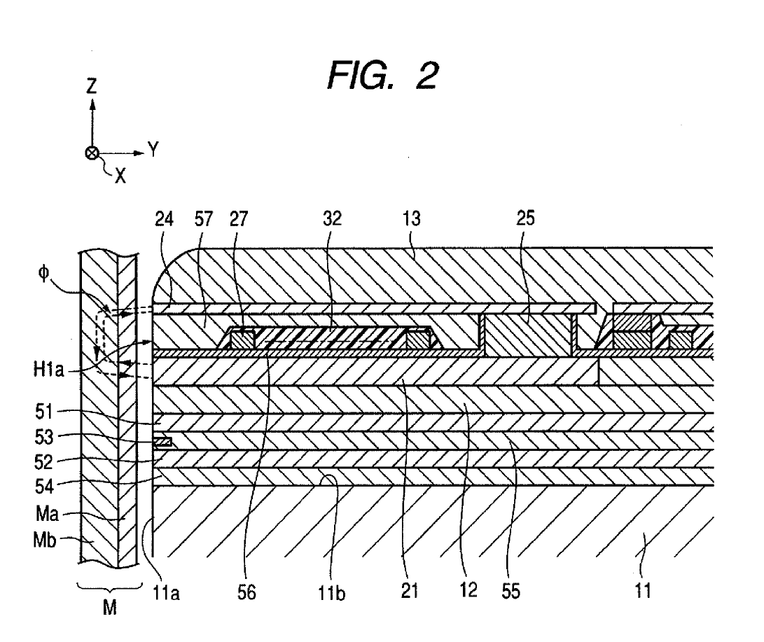

FIG. 1 shows an example of a perpendicular magnetic recording head. In one exemplary embodiment, as shown in FIG. 2, the main magnetic pole layer 24 is formed on the sub magnetic pole layer 21. The main and sub magnetic pole layers 24 and 21 are magnetically connected to each other with a connection layer 25 interposed therebetween. In FIG. 2, reference numeral 56 denotes a coil insulating foundation layer, and reference numeral 57 denotes a gap layer. In FIG. 2, the same reference numerals as those of FIG. 1 denote the same layers as those of FIG. 1.

In the perpendicular magnetic recording head shown in FIGS. 1 and 2, the front end surface 24c of the main magnetic pole layer 24 on the surface H1a has a sufficiently small area relative to the front end surface 21b of the sub magnetic pole layer 21 on the surface H1a. In addition, when recording current is applied to the coil layer 27, a current magnetic field resulting from the recording current flowing through the coil layer 27 induces a recording magnetic field on the main and sub magnetic pole layers 24 and 21. The recording magnetic field leaks to the front end surface 24c of the main magnetic pole layer 24, and the magnetic flux Φ of the recording magnetic field concentrates on the front end surface 24c. The magnetic flux Φ causes the hard film Ma to be magnetized in a perpendicular direction, thereby recording magnetic data.

The main magnetic pole layer 24 shown in FIGS. 1 and 2 is plated with Fe and Ni, Fe and Co, or Fe, Ni and Co. A ratio Cl/Fe between ion strengths of negative-charged Fe and Cl, and a ratio S/Fe between ion strengths of negative-charged S and Fe are less than 10 in measurement by a time-of-flight secondary ion mass spectrometry.

The time-of-flight secondary ion mass spectrometry (hereinafter, referred to as a TOF-SIMS) makes a quantitative analysis that uses a TOF-SIMS V manufactured by ION TOF Corporation. The TOF-SIMS emits a high-speed ion beam (primary ions) on a surface of a fixed sample in a high vacuum condition to remove elements on the surface by spattering. The TOF-SIMS sends positive- or negative-charged ions (secondary ions) generated at this moment in one direction and detects the ions at a position distant by a predetermined distance. Upon spattering, for example, secondary ions that have various masses are created. In the present embodiment, secondary ions that have an ion mass (ion strength) of about 200 are measured. As described above, the TOF-SIMS can measure the positive- and negative-charged secondary ions, but can not simultaneously measure secondary ions that are charged differently from each other.

Accordingly, in the present embodiment, the ratio Cl/Fe of ion strengths between negative-charged Fe and Cl is determined to be less than 10 by taking into account the negative-charged secondary ions.

In the present embodiment, the ratio S/Fe of ion strengths of negative-charged Fe and S is less than 10 in measurement by the TOF-SIMS.

In one embodiment, by reducing the amount of impurities, Cl or S, contained in the soft magnetic film in the present embodiment, it is possible to obtain a higher saturation magnetic flux density Bs with a coercive force Hc maintained to be almost the same, relative to the soft magnetic film (comparative example) that has magnetic elements with almost the same composition ratio as and the ratio Cl/Fe or S/Fe lower than that of the present embodiment. In one embodiment, by using the soft magnetic film in the main magnetic pole layer 24, it is possible to realize high-density recording, and to appropriately reduce the residual amount of magnetization generated from the main magnetic pole layer 24 to the recording medium relative to the related art. As a result, it is possible to appropriately prevent signals recorded on the recording medium from being eliminated due to the residual magnetization.

In one embodiment, since the value of 10 is a threshold value in a case where a plating bath that contains NaCl is used, the ratio Cl/Fe is determined to be less than 10. In the present embodiment, NaCl used to increase the conductivity is not added in the plating bath. However, even though NaCl is added, it is possible to lower the ratio Cl/Fe to a certain degree as the current density of pulse current is lowered. However, even though the current density of pulse current is reduced to about 5 mA/cm², the ratio Cl/Fe can be reduced to about 10 at the most. If the current density of pulse current is reduced even more, it is not possible to reduce the coercive force and thus not possible to obtain an excellent soft magnetic characteristic. In the worst situation, since it is not possible to carry out the plating, the ratio Cl/Fe is limited to 10 in the related art where NaCl is added in the plating bath.

In one embodiment, since NaCl is not added in the plating bath and the ratio Cl/Fe is reduced to be less than 10, the ratio Cl/Fe is determined to be less than 10. For example, in one embodiment, the ratio Cl/Fe is preferably 2 or less. According to the following experiment, the soft magnetic film has a ratio Cl/Fe of 2 or less in the present embodiment, As a result, it is possible to more appropriately obtain a high saturation magnetic flux density Bs. In one embodiment, the ratio Cl/Fe is preferably equal to 0.

The ratio S/Fe of soft magnetic film is less than 10 in the present embodiment and the ratio S/Fe of soft magnetic film is formed using a plating bath that contains saccharine sodium (comparative example) that is not contained in the present embodiment is 10 or more. Accordingly, the ratio Cl/Fe is determined to be less than 10 in the present embodiment.

In the present embodiment, the main magnetic pole layer 24 is preferably made of a FeCoNi alloy where an average composition ratio ‘a’ of Fe is in the range of 66 to 79 mass %, an average composition ratio ‘b’ of Co is in the range of 6.5 to 25.5 mass %, an average composition ratio ‘c’ of Ni is in the range of 8.5 to 20.5 mass %, and the sum of a, b, and c is 100 mass %. Alternatively, in one embodiment, the main magnetic pole layer 24 is made of a FeCo alloy or FeNi alloy. When the main magnetic pole layer 24 is made of a FeCo alloy, an average composition ratio ‘d’ of Fe is in the range of 60 to 80 mass %, an average composition ratio ‘e’ of Co is in the range of 20 to 40 mass %, and the sum of d and e is 100 mass %. When the main magnetic pole layer 24 is made of a FeNi alloy, an average composition ratio ‘f’ of Fe is in the range of 70 to 95 mass %, an average composition ratio ‘g’ of Ni is in the range of 5 to 30 mass %, and the sum of f and g is 100 mass %.

In one embodiment, Fe is contained as a main element in the soft magnetic film. The composition ratio of Fe needs to be higher than that of Co or Ni to obtain a high saturation magnetic density Bs.

Since impurities are contained in the soft magnetic film, the sum of the composition ratios of material elements is not equal to 100 mass %. However, since the amount of impurities is very small (i.e. in ppm units), it is not possible to measure the composition ratio of the impurities, for example, by means of the X-ray fluorescence (XRF). Accordingly, the sum of the composition ratios of material elements is regarded to be equal to 100 mass %.

Since the main magnetic pole layer 24 is formed of the soft magnetic film with the above-mentioned composition ratio, it is possible to appropriately increase the saturation magnetic flux density Bs while the coercive force Hc of main magnetic pole layer 24 is maintained to be low. For example, it is possible to suppress the coercive force Hc (for example, coercive force in the easy-direction of magnetization) within the range of 1 to 2.5 Oe (about 79 to about 197.5 A/m). In one embodiment, it is possible to set the saturation magnetic flux density Bs to about 2.0 T or more and, more preferably, to about 2.1 T or more.

The ion strength of negative-charged Fe is a denominator in the ratio with the ion strength of Cl or S. Thus, the following experiment shows that when the denominator is greatly changed by the composition ratio, the ion strength of negative-charged Fe measured by the TOF-SIMS is not changed very much within the range of composition when the ratios Cl/Fe and S/Fe are determined to be less than 10, even though the amount of Cl and S in the soft magnetic film cannot be known only with the ratios. In one embodiment, the ion strength of negative-charged Fe is set as a denominator when determining the ratio with the ion strength of Cl. In addition, it is possible to appropriately indicate the amount of Cl and S in the soft magnetic film by the ratios Cl/Fe and S/Fe.

The ‘average composition ratio’ is measured with the XRF. For example, an SEA5120 manufactured by SII Corporation is used in the XRF. The XRF is used to measure the average composition ratio by analyzing a characteristic X-ray generated from a sufficiently wide area and depth direction with respect to composition variation that occurs in a minute area.

A method of manufacturing the soft magnetic film (i.e. main magnetic pole layer 24) will be described. In one embodiment, the soft magnetic film is plated by an electrolytic plating method. In the present embodiment, Fe and Ni ions are contained in the plating bath used in an electrolytic plating process to plate FeNi alloy, Fe and Co ions are contained in the plating bath to plate FeCo alloy, and Fe, Ni and Co ions are contained in the plating bath to plate FeNiCo alloy.

However, in the present embodiment, NaCl and saccharine sodium (C₆H₄CONNaSO₂) (stress relaxant) typically contained in the plating bath are not added. NaCl is typically added in the plating bath to increase the conductivity, but it is not added in the present embodiment. In addition to NaCl, chlorides may be added to increase the conductivity in the related art, but the chlorides are preferably not added in the present embodiment. For example, in one embodiment, Cl ions are preferably not contained in the plating bath. However, chlorine may be inevitably contained in the plating bath, which cannot be completely ruled out in the present embodiment. Examples of the chlorine inevitably contained in the plating bath include chloride components that remain in solvents or solutes, chloride components contained in the air, or chloride components attached to the plating bath.

When a soft magnetic film (embodiment) plated with a plating bath that does not contain Cl ions is measured with the TOF-SIMS, the ratio Cl/Fe of ion strengths between negative-charged Fe and Cl is lower than the ratio Cl/Fe of a soft magnetic film (comparative example) plated with a plating bath that contains a chloride, and the ratio Cl/Fe can be set to be less than 10 in the present embodiment as described above. When the chloride is not added in the plating bath, the ratio Cl/Fe is considered to be 0. However, since a small amount of chlorine may be inevitably contained in the plating bath as described above, the ratio Cl/Fe may not be equal to 0. However, according to the following experiment, it is possible to suppress the ratio Cl/Fe to be less than about 10 and, more preferably, to be about 2 or less.

In one embodiment, since the saccharine sodium is not added in the plating bath, it is possible to lower the ratio S/Fe of ion strengths between negative-charged Fe and S when the soft magnetic film according to the present embodiment is measured with the TOF-SIMS. The following experiment shows that the ratio S/Fe can be suppressed to be less than about 10. However, since sulfate, for example, FeSO₄ is contained in the plating bath, the plating bath contains a negative ion SO₄²⁻ including S but containing no saccharine sodium. Accordingly, it is possible to greatly reduce the ratio S/Fe of the soft magnetic film, compared to the ratio S/Fe of the soft magnetic film (comparative example) formed in the plating bath that contains saccharine sodium. In the present embodiment, it is possible to set the ratio S/Fe to be less than about 10 by containing no saccharine sodium in the plating bath.

In one embodiment, since NaCl is not added in the plating bath, the conductivity of plating bath is lowered, thereby deteriorating the uniform electrodeposition performance. Accordingly, it is preferable that more boric acid (H₃BO₃) be added in the present embodiment than the related art so as to improve plating bath environment. Since boric acid of about 25 g/l is added in the related art, boric acid more than 25 g/l is preferably added in the present embodiment. For example, the boric acid is added until it is saturated in the plating bath. As a result, it is possible to suppress pH variation of the plating bath and to maintain uniform electrodeposition performance well.

In the plating bath according to one embodiment, FeSO₄.7H₂O, CoSO₄.7H₂O, NiSO₄.6H₂O, and H₃BO₃ are added and, for example, a small amount (e.g., about 0.02 g/l) of malonic acid is further added. If the malonic acid is added, it is possible to improve the crystallization of soft magnetic film (to obtain a dense film) to improve the saturation magnetic flux density Bs, and to reduce the coercive force Hc. For example, FeSO₄.7H₂O of about 5.6 to 14 g/l, CoSO₄.7H₂O of about 0.6 to 4.6 g/l, NiSO₄.6H₂O of about 4 to 12 g/l, and H₃BO₃ of about 30 g/l are added in the plating bath.

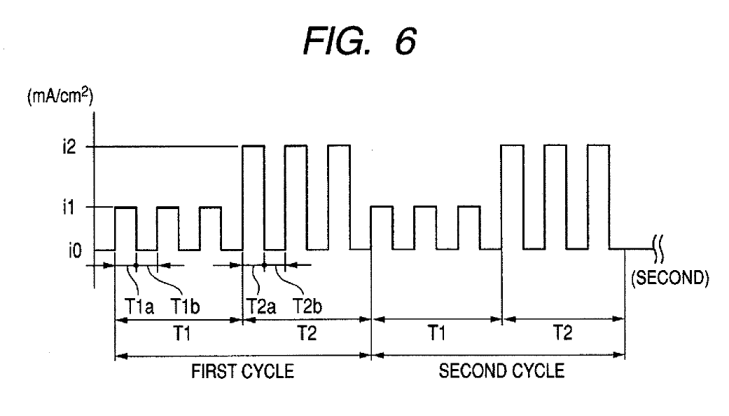

According to one embodiment, the soft magnetic film (main magnetic pole layer 24) is plated by the electrolytic plating method that uses modulation pulses shown in FIG. 6.

As shown in FIG. 6, a pulse current, which has a current density (conductive current density) of i1 in turn-on state, turn-on time of T1a sec, and turn-off time of T1b sec, flows for T1 sec. Subsequently, a pulse current, which has a current density (conductive current density) of i2 larger than i1 in turn-on state, turn-on time of T2a sec, and turn-off time of T2b sec, flows for T2 sec.

As shown in FIG. 6, while the pulse current with the high current density i2 and the pulse current with the low current density i1 are alternately supplied, the soft magnetic film is electrolytically plated. Even though the pulse currents have the same high current density i2 and the same low current density i1 in FIG. 6, different low current densities i1 and different high current densities i2 may be set for every cycle.

In one embodiment, it is possible to enhance uniform electrodeposition performance by using the modulation pulses. A duty ratio is preferably about 0.1 to 0.5. The high current density is set to about 20 mA/cm² (average) and the low current density is set to about 5.5 mA/cm² (average).

The soft magnetic film with a high saturation magnetic flux density and a low coercive force, which is plated as described above, may be used in the sub magnetic pole layer 21 or yoke layer 35 as well as the main magnetic pole layer 24 of the perpendicular magnetic recording head shown in FIGS. 1 to 3. In one embodiment, the soft magnetic film is used in the thin film magnetic head in addition to the perpendicular magnetic recording head.

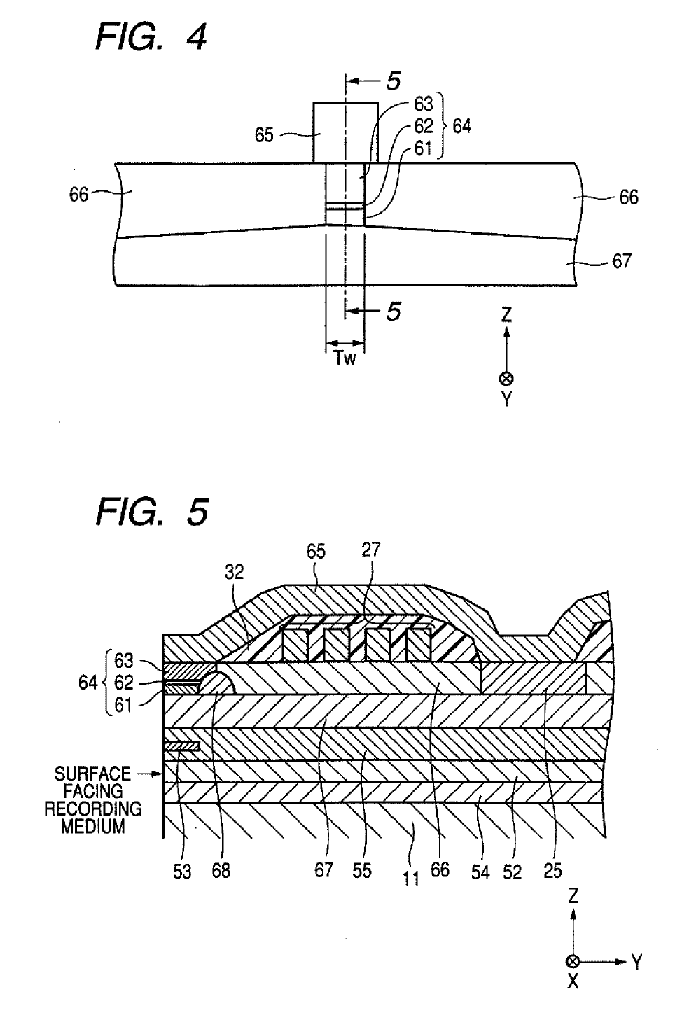

FIG. 4 is a front view (surface viewed from a surface facing a recording medium) of a thin film magnetic head (longitudinal magnetic recording head) according to another embodiment of the invention. FIG. 5 is a cross-sectional view of the longitudinal magnetic recording head as seen from the line 5-5 in the arrow direction of FIG. 4. In FIG. 4, layers disposed below the lower core layer (upper shield layer) are not shown, and the same reference numerals as those of FIGS. 1 and 2 denote the same layers as layers of FIGS. 1 and 2.

In FIG. 5, a lower core layer 67 made of a NiFe alloy or the like is formed on the insulating layer 55. The lower core layer 67 also serves as an upper shield layer of a playback head. As shown in FIG. 5, a Gd crystalline layer 68 made of resist or the like is formed on the lower core layer 67 at a position distant from a surface that faces the recording medium in the height direction (Y-direction). In addition, a magnetic pole portion 64 is formed from the Gd crystalline layer 68 to the surface that faces the recording medium. The magnetic pole portion 64 includes, for example, a lower magnetic pole layer 61, a gap layer 62, and an upper magnetic pole layer 63, which are stacked in this order from the bottom of magnetic pole portion 64. The three layers are continuously plated.

The gap layer 62 is made of a non-magnetic material such as NiP that can be plated. The magnetic pole portion 64 is plated within a very small space. As shown in FIG. 4, the magnetic pole portion 64 is defined to have a track width Tw in a track width direction (X-direction) of the magnetic pole portion 64. In additions as shown in FIG. 5, the magnetic pole portion 64 has a very short depth relative to the lower core layer 67. The track width Tw is about 1.0 μm or less, preferably about 0.5 μm or less, more preferably about 0.2 μm or less. The depth is about 1.0 to 3.0 μm. The height is about 5.0 to 20.0 times the track width Tw.

As shown in FIGS. 4 and 5, an insulating layer 66 is formed on both sides of the magnetic pole portion 64 in the track width direction (X-direction) and on the height side. An upper core layer 65 is formed on the upper magnetic pole layer 63. The rear end of the upper core layer 65 in the height direction is magnetically connected to a connection layer 25.

In one embodiment, as shown in FIG. 5, the upper magnetic pole layer 63, lower magnetic pole layer 61, or upper and lower magnetic pole layers 63 and 61 are plated with a soft magnetic film. In one embodiment, the soft magnetic film is the soft magnetic film of one of the previous embodiments. Accordingly, it is possible to suppress the coercive force Hc of the upper magnetic pole layer 63, lower magnetic pole layer 61, or upper and lower magnetic pole layers 63 and 61, and to increase the saturation magnetic flux density Bs of the upper magnetic pole layer 63, lower magnetic pole layer 61, or upper and lower magnetic pole layers 63 and 61. As a result, it is possible to manufacture a thin film magnetic head that is excellent in terms of high recording density.

### EXAMPLES

(Soft Magnetic Film of Examples)

A plurality of FeCoNi alloys that have different composition ratios is plated using the following plating bath.

(Composition of Plating Bath)

| FeSO₄•7H₂O | 5.6 to 14 | (g/l) |
|---|---|---|
| CoSO₄•7H₂O | 0.6 to 4.6 | (g/l) |
| NiSO₄•6H₂O | 4 to 12 | (g/l) |
| H₃BO₃ | 30 | (g/l) |
| Malonic acid | 0.02 | (g/l) |
| NaCl | 0 | (g/l) |
| Sodium Lauryl Sulfate | 0 | (g/l) |

(Bath Conditions)

| Bath temperature | 30° C. |
|---|---|
| pH | 3.1 to 3.2 |
| Current density of pulse current (high) (peak) | 20 mA/cm² |
| Current density of pulse current (low) (peak) | 5.5 mA/cm² |
| Duty ratio | 0.15 |

A plurality of FeCoNi alloys shown in the following Table 1 was obtained from the plating bath that uses modulation pulses that have the current densities.

TABLE 1

| | | | | Coercive | Coercive | | Saturation |
|---|---|---|---|---|---|---|---|
| | | | | Force | Force | Anisotropic | Magnetic |
| | | | | (easy- | (hard- | Magnetic | Flux |
| | | | | axis) | axis) | Field | Density |
| | Fe | Co | Ni | Hc(E.A) | Hc(H.A) | Hk | Bs |
| Example | [wt %] | [wt %] | [wt %] | [Oe] | [Oe] | [Oe] | [T] |
| | 10.25 | 9.54 | 20.21 | 1.04 | 0.85 | 9.75 | 1.99 |
| | 73.03 | 8.51 | 18.46 | 1.50 | 0.80 | 6.20 | 2.01 |
| | 74.94 | 8.10 | 16.96 | 1.60 | 0.28 | 8.20 | 2.02 |
| | 76.71 | 7.78 | 15.52 | 1.40 | 0.60 | 6.15 | 2.05 |
| | 77.10 | 7.20 | 15.70 | 1.68 | 0.65 | 5.35 | 2.06 |
| 1 | 78.88 | 6.55 | 14.57 | 1.65 | 0.70 | 4.50 | 2.04 |
| | 77.93 | 7.48 | 14.59 | 1.75 | 1.08 | 6.25 | 2.05 |
| | 75.12 | 10.50 | 14.39 | 1.95 | 1.45 | 7.85 | 2.08 |
| | 73.16 | 12.99 | 13.85 | 2.30 | 0.88 | 6.15 | 2.09 |
| | 73.34 | 12.36 | 14.30 | 1.88 | 0.80 | 6.25 | 2.09 |
| | 71.10 | 14.47 | 14.44 | 1.70 | 0.65 | 8.40 | 2.07 |
| | 69.18 | 17.31 | 13.52 | 1.74 | 0.70 | 9.40 | 2.10 |
| | 69.70 | 18.60 | 11.70 | 2.08 | 0.80 | 9.45 | 2.10 |
| | 68.91 | 19.66 | 11.43 | 2.30 | 1.40 | 11.00 | 2.12 |
| | 70.32 | 19.06 | 10.62 | 2.50 | 1.00 | 9.10 | 2.14 |
| | 70.41 | 18.61 | 10.99 | 1.64 | 0.95 | 10.05 | 2.11 |
| | 69.35 | 18.34 | 12.32 | 1.52 | 0.90 | 11.30 | 2.08 |
| 2 | 68.93 | 20.74 | 10.33 | 2.00 | 1.20 | 10.35 | 2.14 |
| | 67.14 | 23.20 | 9.66 | 2.38 | 0.90 | 11.40 | 2.13 |
| | 66.65 | 23.20 | 10.16 | 1.90 | 0.85 | 13.10 | 2.12 |
| | 65.38 | 25.28 | 9.34 | 2.28 | 0.95 | 15.20 | 2.12 |
| | 69.28 | 21.96 | 8.76 | 2.52 | 1.60 | 12.70 | 2.12 |
| | 66.15 | 23.61 | 10.25 | 1.40 | 0.75 | 14.15 | 2.09 |
| | 67.75 | 23.64 | 8.61 | 1.72 | 1.05 | 12.05 | 2.10 |

(Soft Magnetic Film of Comparative Examples)

A plurality of FeCoNi that have different composition ratios were plated using the following plating bath.

(Composition of Plating Bath)

| FeSO₄•7H₂O | 7.0 to 22 | (g/l) |
|---|---|---|
| CoSO₄•7H₂O | 0.8 to 7.4 | (g/l) |
| NiSO₄•6H₂O | 10 | (g/l) |
| H₃BO₃ | 25 | (g/l) |
| Malonic acid | 0.01 | (g/l) |
| NaCl | 25 | (g/l) |
| Sodium Lauryl Sulfate | 0.01 | (g/l) |

(Bath Conditions)

| Bath temperature | 30° C. |
|---|---|
| pH | 3.1 to 3.2 |
| Current density of pulse current (high) (peak) | 20 mA/cm² |
| Current density of pulse current (low) (peak) | 5.5 mA/cm² |
| Duty ratio | 0.15 |

A plurality of FeCoNi alloys shown in the following table 2 was obtained from the plating bath that uses modulation pulses that have the current densities.

TABLE 2

| | | | | Coercive | Coercive | | Saturation |
|---|---|---|---|---|---|---|---|
| | | | | Force | Force | Anisotropic | Magnetic |
| | | | | (easy- | (hard- | Magnetic | Flux |
| | | | | axis) | axis) | Field | Density |
| Comparative | Fe | Co | Ni | Hc(E.A) | Hc(H.A) | Hk | Bs |
| Example | [wt %] | [wt %] | [wt %] | [Oe] | [Oe] | [Oe] | [T] |
| | 78.51 | 8.15 | 15.35 | 6.1 | 2.7 | | 2.00 |
| | 68.40 | 10.99 | 20.61 | 0.8 | 0.3 | 11.5 | 1.97 |
| | 71.26 | 9.18 | 19.56 | 1.1 | 0.5 | 9.9 | 1.97 |
| | 75.58 | 8.06 | 16.37 | 1.1 | 0.5 | 6.3 | 2.02 |
| 1 | 79.23 | 7.10 | 13.67 | 1.3 | 0.9 | 6.1 | 1.98 |
| | 81.51 | 6.31 | 12.19 | 1.4 | 0.7 | 4.2 | 2.01 |
| | 78.60 | 9.68 | 11.73 | 1.6 | 0.9 | 5.4 | 1.99 |
| | 80.69 | 8.36 | 10.96 | 1.9 | 1.1 | 4.5 | 1.98 |
| | 79.04 | 10.92 | 10.05 | 1.7 | 0.9 | 5.4 | 2.03 |
| | 77.32 | 13.39 | 9.29 | 2.2 | 1.1 | 6.3 | 2.03 |
| | 73.60 | 15.64 | 10.76 | 2.0 | 1.8 | 11.3 | 2.03 |
| | 75.71 | 15.33 | 8.96 | 2.8 | 1.7 | 6.8 | 2.06 |
| | 79.13 | 12.33 | 8.55 | 2.6 | 1.6 | 5.1 | 2.04 |
| | 78.96 | 14.82 | 8.22 | 2.2 | 1.2 | 5.1 | 2.05 |
| | 74.07 | 18.45 | 7.48 | 2.5 | 1.9 | 10.2 | 2.04 |
| | 71.72 | 21.18 | 7.10 | 3.4 | 1.6 | 7.6 | 2.09 |
| | 73.91 | 19.66 | 6.43 | 3.5 | 1.7 | 7.3 | 2.06 |
| 2 | 70.14 | 22.12 | 7.75 | 2.6 | 1.1 | 10.6 | 2.05 |
| | 72.07 | 20.38 | 7.11 | 3.5 | 1.7 | 8.2 | 2.07 |
| | 75.41 | 18.59 | 6.00 | 3.5 | 1.8 | 7.0 | 2.04 |
| | 71.69 | 23.26 | 6.05 | 5.3 | 2.8 | 8.0 | 2.07 |
| | 67.30 | 26.85 | 5.85 | 7.8 | 3.3 | 6.3 | 2.03 |

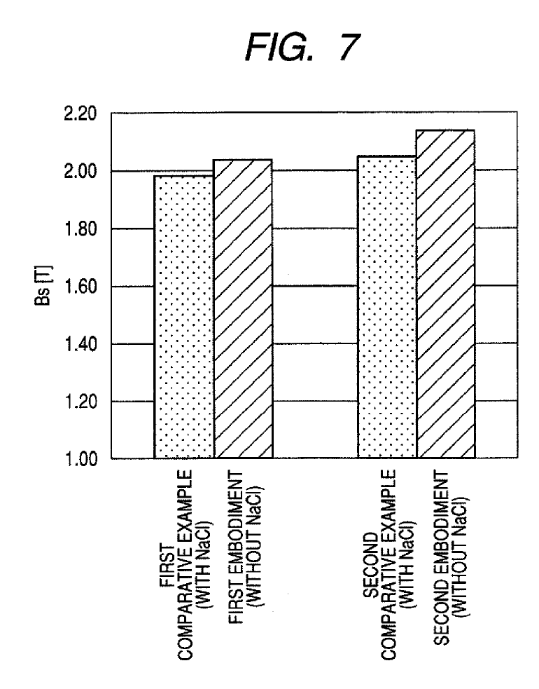

Samples in first and second examples are extracted from samples in a plurality of examples shown in Table 1. In addition, samples in first and second comparative examples are extracted from samples in a plurality of comparative examples shown in Table 2. A sample in the first example contains the amount of Fe that is about 10 mass % more than that of a sample in the second example. A sample in the first comparative example contains almost the same amount of Fe as the sample in the first example. A sample in the second comparative example contains almost the same amount of Fe as the sample in the second example. FIG. 7 is a graph that shows the saturation magnetic flux densities of the above-mentioned four samples. In the graph, the samples in the first example and first comparative example that have almost the same amount of Fe are compared with each other, and the samples in the second example and second comparative example that have almost the same amount of Fe are compared with each other.

FIG. 7 shows that the sample in the first example has saturation magnetic flux density Bs higher than the sample in the first comparative example, and the sample in the second example has saturation magnetic flux density Bs higher than the sample in the second comparative example. The two examples have saturation magnetic flux density Bs exceeding 2.0 T. In addition, Tables 1 and 2 show that the sample in the first example has almost the same coercive force Hc as the sample in the first comparative example, and the sample in the second example has almost the same coercive force Hc as the sample in the second comparative example.

For example, when the composition ratios of magnetic elements are almost identical to each other, it can be seen that the samples in the examples can maintain almost the same low coercive force Hc as the samples in the comparative examples, and obtain the saturation magnetic flux density Bs higher than the samples in the comparative examples.

A quantitative analysis is performed for each of the samples in the first and the second examples and the first and the second comparative examples by the TOF-SIMS. TOF-SIMS V manufactured by ION TOF Corporation was used in the TOF-SIMS. Ion strengths of negative-charged secondary ions, which have a mass of about 200, were obtained from the measurement by the TOF-SIMS. The following Table 3 shows a part of negative-charged secondary ions.

TABLE 3

| | H(1) | O(16) | OH(17) | BO(26) | BO(27) | S(32) | CI(35) | CI(37) | BO2(43) | Fe(56) |
|---|---|---|---|---|---|---|---|---|---|---|
| First | 62593 | 1811533 | 1839969 | 64801 | 242968 | 26490 | 1544884 | 495941 | 450501 | 21187 |
| Comparative | | | | | | | | | | |
| example | | | | | | | | | | |
| Second | 33875 | 1238182 | 882110 | 43962 | 156428 | 42589 | 1459064 | 464881 | 301485 | 18183 |
| Comparative | | | | | | | | | | |
| example | | | | | | | | | | |
| First | 18339 | 1131029 | 300727 | 19767 | 69992 | 115079 | 12057 | 3902 | 136235 | 22528 |
| Example | | | | | | | | | | |
| Second | 19772 | 1432352 | 297934 | 22598 | 81168 | 156163 | 27960 | 8888 | 163758 | 20119 |
| Example | | | | | | | | | | |

Table 3 shows that numerals in parentheses indicate masses. As shown in Table 3, ion strengths of Cl(35) and Cl(37) in the first and the second examples are extremely smaller than those of Cl(35) and Cl(37) in the first and the second comparative examples.

Table 3 shows that the ion strengths of negative-charged Fe(56) are not changed very much in the first and the second examples and the first and the second comparative examples. For example, even though the first example is different from the second example by 10 mass % in terms of the amount of Fe of the soft magnetic film, the first and the second examples are similar to each other in terms of the ion strength of negative-charged Fe(56). The first and the second examples and the first and the second comparative examples are different from each other in terms of ion strengths of other negative-charged secondary ions except Cl, S and Fe. Accordingly, the ion strength of Fe is set as the denominator in the ratio between the ion strength of Fe and the ion strength of Cl.

The ratio Cl/Fe is obtained by summing up the ion strength of Cl(35) and the ion strength of Cl(37) that are shown in Table 3, and dividing the resultant sum by the ion strength of negative-charged Fe(56). Similarly, the ratio S/Fe of each sample is obtained from Table 3.

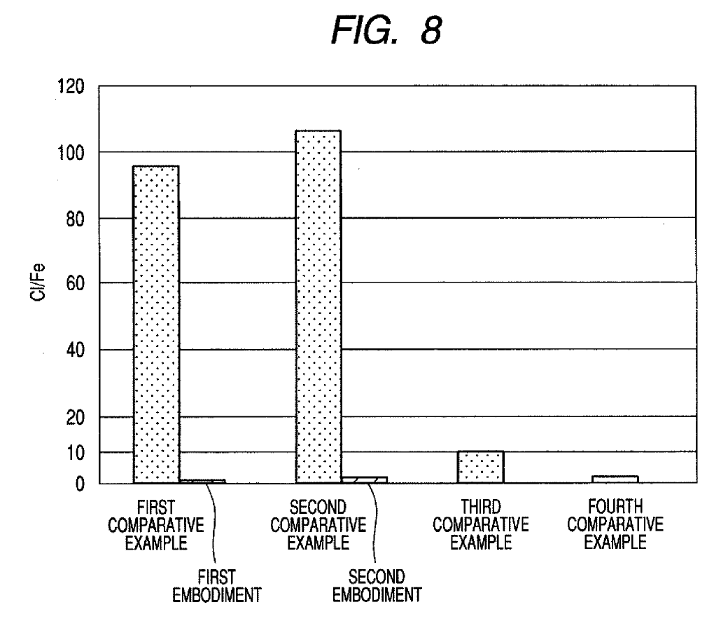

FIG. 8 is a graph of the ratio Cl/Fe. In FIG. 8, the ratio Cl/Fe of the soft magnetic film measured by a TOF-SIMS in third and fourth comparative examples is further indicated.

The composition of plating bath used to form the soft magnetic film of the third comparative example is as follows:

| | |
|---|---|
| FeSO₄•7H₂O | 8.0 (g/l) |
| CoSO₄•7H₂O | 0.3 (g/l) |
| NiSO₄•6H₂O | 3.5 (g/l) |
| H₃BO₃ | 25 (g/l) |
| Malonic acid | 0.01 (g/l) |
| NaCl | 25 (g/l) |
| Sodium Lauryl Sulfate | 0.01 (g/l) |

The bath conditions are almost the same as those of the comparative example except that the current density of pulse current was set to be as low as 5 mA/cm². The value 5 mA/cm² is a limit value of the current density of pulse current. If the current density of pulse current is lower than 5 MA/cm², it is difficult to reduce the coercive force and thus not possible to obtain excellent soft magnetic characteristics. In the worst case, for example, the plating is not possible.

The ion strengths of negative-charged Fe and Cl in the soft magnetic film of the third comparative example were measured by the TOF-SIMS. As a result, the ratio Cl/Fe was almost 10.

The composition of plating bath used to form the soft magnetic film of the fourth comparative example is as follows;

| | | |
|---|---|---|
| FeSO₄•7H₂O | 9 | (g/l) |
| CoSO₄•7H₂O | 0.3 | (g/l) |
| NiSO₄•6H₂O | 10 | (g/l) |
| H₃BO₃ | 25 | (g/l) |
| Malonic acid | 0.02 | (g/l) |
| NaCl | 25 | (g/l) |
| Sodium Lauryl Sulfate | 0.01 | (g/l) |
| Saccharine sodium | 1 | (g/l) |

The bath conditions are almost the same as those of the comparative example. In the fourth comparative example, the saccharine sodium is added in the plating bath.

The ion strengths of negative-charged Fe and Cl in the soft magnetic film of the fourth comparative example were measured by the TOF-SIMS. As a result, the ratio Cl/Fe were almost the same as the ratio Cl/Fe in the first and the second examples.

It can be seen from FIG. 8 that the ratio Cl/Fe in the first and the second examples is lower than the ratio Cl/Fe in the first to the third comparative examples in which the plating bath contains NaCl but does not contain saccharine sodium. In the third comparative example in which the current density of pulse current is reduced up to the limit value, the ratio Cl/Fe is lower than that in the first and the second comparative examples. However, the ratio Cl/Fe has a limit value of 10. In the present example, it is possible to reduce the ratio Cl/Fe to be less than 10. In addition, since the ratio Cl/Fe of the first comparative example is about 0.7 and the ratio Cl/Fe of the second example is about 1.8, it is possible to reduce the ratio Cl/Fe to 2 or less in the present example.

Even though the compound NaCl is not included in the composition of plating bath of the example, since chlorine is inevitably included in solvents or solutes, air or is attached to the plating bath, the ion strength of Cl is not 0 as indicated in Table 3. However, even though there is chlorine as described above, since NaCl is not added in the plating bath, it is possible to suppress the ratio Cl/Fe to be less than 10 and, more preferably, to 2 or less.

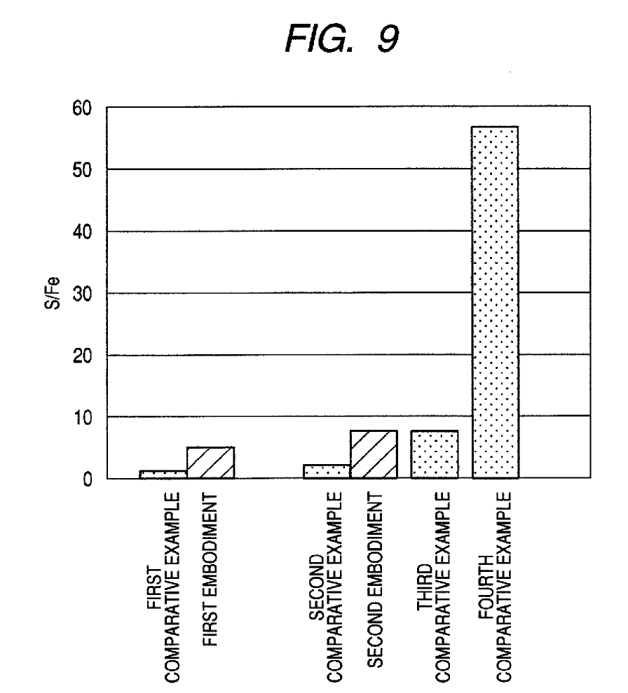

FIG. 9 is a graph of the ratio S/Fe. It can be seen from FIG. 9 that the ratio S/Fe of the fourth comparative example in which the plating bath contains saccharine sodium is significantly larger than other samples. The ratio S/Fe in one embodiment and the ratio S/Fe in another embodiment are about 5.1 and 7.7, respectively, which are less than 10.

In consideration of the above-mentioned experiment results, the ratio Cl/Fe of the ion strengths of negative-charged Fe and Cl and the ratio S/Fe of the ion strengths of negative-charged S and Cl that are measured by a TOF-SIMS are determined to be less than 10 in the present example.

In the present example, since NaCl is not added in the plating bath, a large amount of boric acid is added relative to the comparative examples in order to suppress pH variation. However, as indicated in Table 3, the ion strength of negative-charged BO(26) or BO₂(43) was larger in the comparative example than in the example. Accordingly, with respect to Bo(26) or the like, it can be understood that the ion strength does not become large simply because a large amount of boric acid was added in the plating bath.

The ion strengths of positive-charged secondary ions are obtained by a TOF-SIMS in the samples of the first and the second examples and the first and the second comparative examples. Table 4 shows the ion strengths of positive-charged secondary ions.

TABLE 4

| | NaCl | Na(23) | Fe(56) | Co(59) | Ni(58) | Na % |
|---|---|---|---|---|---|---|
| First | Contained | 20233 | 784478 | 85061 | 89856 | 2.1 |
| Comparative | | | | | | |
| example | | | | | | |
| Second | Contained | 18755 | 703416 | 283856 | 61810 | 1.8 |
| Comparative | | | | | | |
| example | | | | | | |
| First Example | Not | 1015 | 486484 | 163051 | 299655 | 0.1 |
| | contained | | | | | |
| Second | Not | 459 | 727214 | 265829 | 75945 | 0.04 |
| Example | contained | | | | | |

In Table 4, numerals in parentheses indicate masses. As shown in Table 4, the ion strength of Na(23) was greatly reduced in first and second examples relative to in first and second comparative examples.

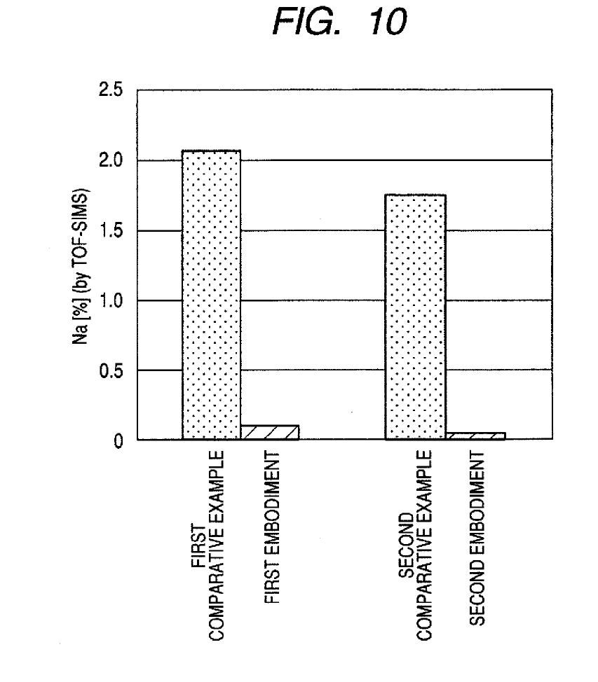

FIG. 10 shows the ion strength ratio of Na [{Na/(Na+Fe+Co+Ni)}×100](%) of each sample that is obtained from the measurement results of Table 4. As shown in FIG. 10, the ion strength ratio of Na was greatly reduced in the first and the second examples relative to in the first and the second comparative examples. The ion strength ratios of Na are about 0.1% and 0.04% in the first and the second examples, respectively. The ion strength ratios of Na are about 2.1% and 1.8% in the first and the second comparative examples, respectively.

It can be seen from the experiment results that the ion strength ratio of Na is preferably suppressed to about 1.5% or less and, more preferably, to about 1.0% or less.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A soft magnetic film that is plated with Fe and Ni, Fe and Co, or Fe, Ni and Co,
wherein a ratio Cl/Fe of ion strengths between negative-charged Fe and Cl and a ratio S/Fe of ion strengths between negative-charged Fe and S are less than about 10 in measurement by a time-of-flight secondary ion mass spectrometry.

2. The soft magnetic film according to claim 1, wherein the strengths are measured by a time-of-flight secondary ion mass spectrometry.

3. The soft magnetic film according to claim 1, wherein the ratio Cl/Fe is about 2 or less.

4. A thin film magnetic head comprising:
a main magnetic pole layer that has a track width on a surface that faces a recording medium;
a sub magnetic pole layer that has a width wider than the main magnetic pole layer and faces the main magnetic pole layer in a film thickness direction; and
a coil layer that is operative to apply a recording magnetic field to the main and sub magnetic pole layers,
wherein magnetic data is recorded on the recording medium by a perpendicular magnetic field concentrated on the main magnetic pole layer, and
at least the main magnetic pole layer is plated with the soft magnetic film.

5. The thin film magnetic head according to claim 4, wherein the soft magnetic film is plated with Fe and Ni, Fe and Co, or Fe, Ni and Co; and
wherein a ratio Cl/Fe of ion strengths between negative-charged Fe and Cl and a ratio S/Fe of ion strengths between negative-charged Fe and S are less than 10.

6. The thin film magnetic head according to claim 5, wherein the strengths are measured by a time-of-flight secondary ion mass spectrometry.

7. The thin film magnetic head according to claim 5, wherein the ratio Cl/Fe is 2 or less.

8. A method of manufacturing a soft magnetic film comprising:
preparing a plating bath that contains no chloride and no saccharine sodium, and contains Fe and Ni ions, Fe and Co ions, or Fe, Ni and Co ions; and
plating the soft magnetic film in the plating bath.

9. The method according to claim 5, adding boric acid to the plating bath until the boric acid is saturated in the plating bath when preparing the plating bath.

10. A method of manufacturing a thin film magnetic head that includes a main magnetic pole layer that has a track width on a surface that faces a recording medium, a sub magnetic pole layer that has a width wider than the main magnetic pole layer so as to face the main magnetic pole layer in a film thickness direction, and a coil layer that applies a recording magnetic field to the main and sub magnetic pole layers, so that magnetic data is recorded on the recording medium by a perpendicular magnetic field concentrated on the main magnetic pole layer comprising:
plating the main magnetic pole layer with a soft magnetic film that contains Fe and Ni ions, Fe and Co ions, or Fe, Ni and Co ions.

11. The method according to claim 10, wherein the soft magnetic film is plated in a plating bath that contains no chloride and no saccharine sodium.

12. The method according to claim 11, wherein boric acid is contained in the plating bath until the boric acid is saturated in the plating bath.
